(19) United States
(12) Patent Application Publication
(10) Pub. No.: US 2011/0015967 A1
(43) Pub. Date: Jan. 20, 2011

(54) METHODOLOGY TO IDENTIFY EMERGING ISSUES BASED ON FUSED SEVERITY AND SENSITIVITY OF TEMPORAL TRENDS

(75) Inventors: Sabyasachi Bhattacharya, Bangalore (IN); Soumen De, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/505,075

(22) Filed: Jul. 17, 2009

(51) Int. Cl. G06Q 10/00; G06Q 50/00

(52) U.S. Cl. 705/10; 705/7

(57) ABSTRACT

A method for temporal trend detection employing non-parametric techniques. A set of discrete data is provided and a rank is assigned to the data based on both sensitivity and severity of the data. The method statistically ranks the ranked data by categorizing the data in bins defined by an average positional ranking that identifies the severity of the data for each sensitivity category provided by a bin. The method then clusters the statistically ranked data that has been categorized by average positional ranking so as to detect changes in the data. Clustering the statistically ranked data can include using a multi-nominal hypothesis testing procedure. The method then identifies trends in the data based on the detected changes.

### BACKGROUND OF THE INVENTION

1. Field of the Invention

This invention relates generally to a method for temporal trend detection employing non-parametric techniques and, more particularly, to a method for extracting temporal trends by employing non-parametric techniques using the sensitivity and severity of data, and classifying the trends in various ways to enable different data driven decisions.

2. Discussion of the Related Art

The collection of product or process data, and analysis thereof, enables a user to make various data driven decisions. Examples include warranty and service data collected by a product company, demographic data collected by a state, and meteorological data collected by weather scientists. The purpose of the collection and interpretation of such product or process data is to reduce costs, both tangible and intangible, by early detection of emerging issues. Due to the nature of the data itself, data collection constraints or data storage constraints, the data collected is usually of a discrete nature, such as repairs undertaken per warranty event or mortality rate per state.

Non-parametric statistics is a branch of statistics concerned with non-parametric statistical models and non-parametric inference, including non-parametric statistical tests. Non-parametric methods are often referred to as distribution free methods because they do not rely on assumptions that the data is drawn from a given probability distribution. The term non-parametric statistic can also refer to a statistic whose interpretation does not depend on the population fitting any parameterized distribution. Order statistics are one example of such a statistic that plays a central role in many non-parametric approaches.

Non-parametric models differ from parametric models in that the model structure is not specified as a priority, but instead is determined from data. The term non-parametric is not meant to imply that such models completely lack parameters, but that the number and nature of the parameters are flexible and not fixed in advance.

Non-parametric methods of statistical analysis are frequently utilized as alternatives to traditional statistical methods based on normal theory assumptions. Benefits of the use of non-parametric methods include wider applicability in terms of the level of measurements required in less stringent distributional assumptions, as well as the opportunity for increased statistical power. Non-parametric methods of statistical analysis are frequently presented as alternatives to traditional statistical methods based on normal theory assumptions. Common reasons given for their use include the level of measurement of the data and the validity of such methods under less stringent distributional assumptions. For example, non-parametric tests, such as the Wilcoxon signed rank test, the Mann-Whitney test and the Kruskal-Wallis test, are based only on some form of ranking of the variable of interest, and hence, are applicable in situations where traditional t and F tests are not. Likewise, such tests do not require normally distributed data, but only less restricted conditions, such as symmetry.

As is well known in the art, non-parametric methods are often used for studying populations that take on a ranked order. Such non-parametric methods may be necessary when data has a ranking, but no clear numerical interpretation. Furthermore, because non-parametric methods make fewer assumptions their applicability is much wider than parametric methods, and due to the reliance on fewer assumptions, non-parametric methods are typically more robust.

Known temporal trend methods assume that claims come from a known distribution, such as a Poisson distribution. The problem with such an approach is that it is not dynamic and, in the context of vehicle warranty claims, does not consider the sensitivity of miles driven. Additional limitations of known trend detection methods include: (1) they do not fuse the sensitivity and severity of the variables to detect and classify trends; (2) they usually assume that the data comes from a parametric distribution, which at times may not be a correct assumption; (3) they do not perform within-cluster analyses to provide causal (physics based) and non-causal relationships of variables within each cluster; (4) they classify trends based on thresholds, hence the need to develop adequate confidence levels to balance type1/type 2 errors; and (5) any missing data is interpolated leading to interpolation related inaccuracies.

### SUMMARY OF THE INVENTION

In accordance with the teachings of the present invention, a method for temporal trend detection employing non-parametric techniques is disclosed. A set of discrete data is provided and a rank is assigned to the data based on both sensitivity and severity of the data. The method statistically ranks the ranked data by categorizing the data in bins defined by an average positional ranking that identifies the severity of the data for each sensitivity category provided by a bin. The statistical ranking can include categorizing the data based on occurrence and assigning a positional weight for each rank of data, were a probability of occurrence is calculated based on the rank of the data and the positional weight of the data, an average positional rank of the data is calculated based on the probability of occurrence and the average positional rank is calculated based on the probability of occurrence and the positional weight. The method then clusters the statistically ranked data that has been categorized by average positional ranking so as to detect changes in the data. Clustering the statistically ranked data can include using a multi-nominal hypothesis testing procedure. The method then identifies trends in the data based on the detected changes.

Additional features of the present invention will become apparent from the following description and appended claims, taken in conjunction with the accompanying drawings.

### BRIEF DESCRIPTION OF THE DRAWINGS

FIG. 1 is a flow diagram of a process for detecting emerging trends;

FIG. 2 is a graph showing Kernel density estimation with claims on the y-axis and bins for miles driven on the x-axis;

FIG. 3 is a flow diagram of a process for data clustering and change detection;

FIG. 4 is a graph showing how APR based trends change with different time windows;

FIG. 5 is a graph with time on the x-axis and proposed APR metrics on the y-axis illustrating the results of a method showing an emerging issue for a given labor code; and

FIG. 6 is a graph with time on the x-axis and proposed APR metrics on the y-axis illustrating the results of a method showing a by-gone issue for a given labor code.

### DETAILED DESCRIPTION OF THE EMBODIMENTS

The following discussion of the embodiments of the invention directed to a method for temporal trend detection employing non-parametric methods is merely exemplary in nature, and is in no way intended to limit the invention or its applications or uses. For example, the present invention will be described below as having particular application for detecting vehicle warranty issues. However, as will be appreciated by those skilled in the art, the present invention will having application for predicting trends for other things.

The present invention proposes a method for temporal trend detection employing non-parametric techniques that includes collecting service data and operational data as different triggers. The proposed invention overcomes the aforementioned problems in the prior art in various ways, including: (1) temporal trend detection and classification of different trends for discrete variables; (2) missing data is not interpolated; (3) the proposed invention does not depend on a threshold function to detect trends; (4) fusion of sensitivity (e.g., mileage) and severity (e.g., rank-based claim counts); and (5) clustering of the groups of variables showing similar trends and analyzing causal relationship variables within each cluster. All of these improvements ensure a more robust trend prediction, thereby enhancing root cause analyses and allowing for better data driven business decisions.

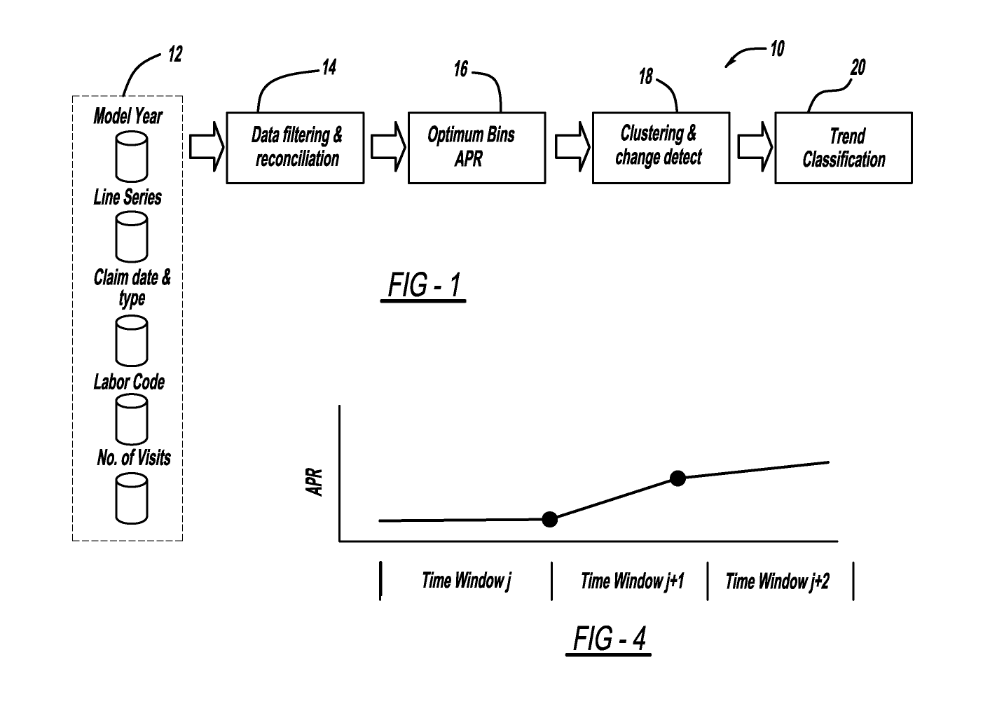

FIG. 1 is a high level flow diagram 10 of a process for detecting emerging trends using a non-parametric method. Various data inputs are provided at box 12 and may include any suitable data, such as data for vehicle warranty model year, line series, claim date and type, labor code, number of visits, etc. Data from the box 12 is filtered and reconciled at box 14, and optimum bins of average positional ranking (APR) of the data, or statistical ranking of the data, are created at box 16. Once the optimum bins of the APR of the data are determined at the box 16, the data is clustered and changes are detected at box 18. The changes over time that are detected at the box 18 are classified as trends at box 20. Based on the trend classification, a user is able to determine whether an emerging trend is developing or a trend or an issue is a by-gone issue. An emerging issue is one that has an increasing trend where some problem or event is occurring more frequently with time. A by-gone issue is one where the trend is decreasing and thus is occurring less often with time. This allows the user to effectively apply resources to monitor sensitive time periods to ensure adequate management of issues, particularly emerging issues.

Data filtering and reconciliation at the box 14 includes, in addition to collecting the data listed above, assigning a rank to each labor code. Rank is determined based on the sensitivity and severity for each labor code. One skilled in the art will readily recognize that the fusion of the sensitivity and the severity of data could be utilized in a broad range of data collections. While labor codes of warranty claims are used herein, there use should be construed as a non-limiting embodiment.

The frequency of occurrence of warranty claims for each labor code is collected, as well as the mileage on the vehicle, at the time a warranty claim is made. In addition, the sensitivity of claims for each labor code is analyzed based on the mileage of the vehicle, as will be discussed in more detail below. By collecting this information both the sensitivity and the severity for each labor code can be fused to provide a more robust predictor of what is an emerging issue and what a by-gone issue is.

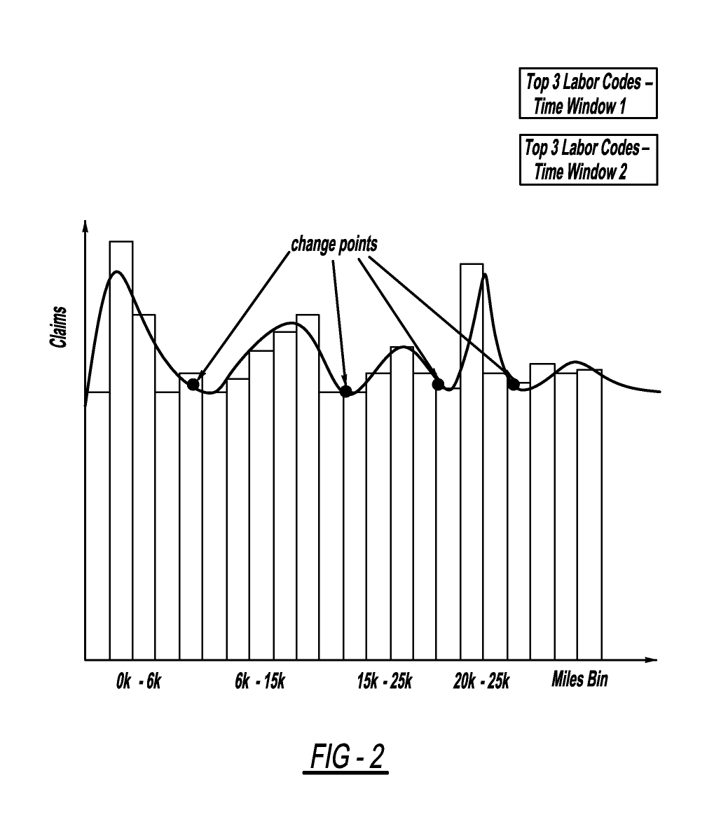

FIG. 2 is a graph illustrating a Kernel density estimation with claims on the y-axis and bins for miles driven on the x-axis, where the optimum miles in which claims are sensitive is determined. First, a plot histogram of claims based on miles is generated, and Kernel density is estimated based on the plot histogram utilizing the equation:

$${\hat{f}}_{h} ( x ) = \frac{1}{Nh} {\sum }_{i = 1}^{N} K ( \frac{x - {x}_{i}}{h} ) \qquad ( 1 )$$

Where \hat{f}ₕ is a Kernel density approximation function, K is some Kernel function, x is an ID sample of a random sample variable, and h is bandwidth (soothing function).

Using equation (1), the user may identify different modes, detect change points between consecutive modes and categorize different mileage bins. Thus, rank in selected bins is more sensitive to claims, and are accordingly ranked higher. In this way, the user is able to define the degree of sensitivity of each labor code for each mileage category.

As discussed above, the box 16 provides statistical ranking that includes determining APR, which is a metric to capture the severity of a labor code for each sensitivity category. The APR is equal to the average of positional weights plus the probability of occurrences. Table 1 shows the top N labor code ranks against claims, which illustrates an example of how the labor codes (LC) for each warranty claim may be categorized. Table 1 shows a rank based on incidence from 1-5 in the vertical direction and miles driven in the horizontal direction. Labor codes, such as E7700, H0127, R0760, etc., are identified in the table and are assigned a number as to how often they have occurred during the particular mileage time for a particular column. The number of occurrences determines the ranking for the particular labor code.

TABLE 1

| RANK | | | | | |
|---|---|---|---|---|---|
| (based on | | | | | |
| incidence) | 0K-6K | 6K-15K | 15K-20K | 20K-25K | 25K-36K |
| 1 | E7700 | N0110 | C2200 | D1180 | B0763 |
| | (12) | (11) | (5) | (16) | (22) |
| 2 | H0127 | E7700 | R0762 | N0100 | B7876 |
| | (11) | (8) | (4) | (14) | (20) |
| 3 | N0912 | C2200 | H0122 | N0110 | C6030 |
| | (8) | (7) | (3) | (10) | (17) |
| 4 | H2882 | L2300 | H0121 | R0760 | J6441 |
| | (3) | (6) | (2) | (6) | (15) |
| 5 | H0137 | N0914 | K5225 | E0203 | R0760 |
| | (11) | (3) | (1) | (4) | (14) |

For each labor code, the process will filter and sort the warranty claims, categorized by labor code based on the number of occurrences (the severity), the mileage on the vehicle when the warranty claim arose (the sensitivity), and the time window during which the warranty claim arose. Examples of possible time windows are a month, a week or a day. Once the information is sorted, the rank for each labor code can be determined. As shown in Table 1, the labor code E7700 is ranked the highest in the 0 to 6,000 miles range. This is because there were twelve warranty claims based on the labor code E7700 during time window 1.

Table 2 gives a positional weight for each rank, where the highest rank is assigned the highest positional weight. Thus, Table 1 illustrates how each rank is assigned a positional weight. Positional weights can be chosen arbitrarily as long as the rank hierarchy is respected. Thus, when fusing the sensitivity and severity of claims, those labor codes with the highest severity and the greatest sensitivity will be ranked highest, and accordingly, will be given the greatest positional weight.

TABLE 2

| Rank | Positional Weight |
|---|---|
| 1 | 0.5 |
| 2 | 0.4 |
| 3 | 0.3 |
| 4 | 0.2 |
| 5 | 0.1 |

After the positional weight has been assigned to each rank, average positional rank calculations are performed at the box 16. As illustrated in Table 3, once the rank and the positional weight for each rank are determined, the probability of occurrence is calculated to be able to determine the average positional rank. For each labor code for each time window, the probability of occurrence is equal to the number of categories over the total number of categories. Thus, for each labor code, the sum of the probability of occurrence and the average positional weight equals the average positional rank. The APR for each labor code is stored at the box 16 to be clustered in various ways to detect changes.

TABLE 3

| | Probability | Average | |
|---|---|---|---|
| LC# | (Occurrence) | (Positional weight) | APR |
| E7700 | (2/5) = 0.4 | (0.5 + 0.4)/2 = 0.45 | (0.4 + 0.45) = 0.85 |
| R0760 | (2/5) = 0.4 | (0.2 + 0.1)/2 = 0.15 | (0.4 + 0.15) = 0.55 |
| N0912 | 0.2 | 0.3 | 0.6 |
| H2882 | 0.2 | 0.2 | 0.4 |
| . | . | . | . |
| . | . | . | . |
| . | . | . | . |

Now that the fused sensitivity and severity data has been assigned an APR, this information can be clustered and the changes can be detected at the box 18. Chosen APRs are tracked over time to determine their trend.

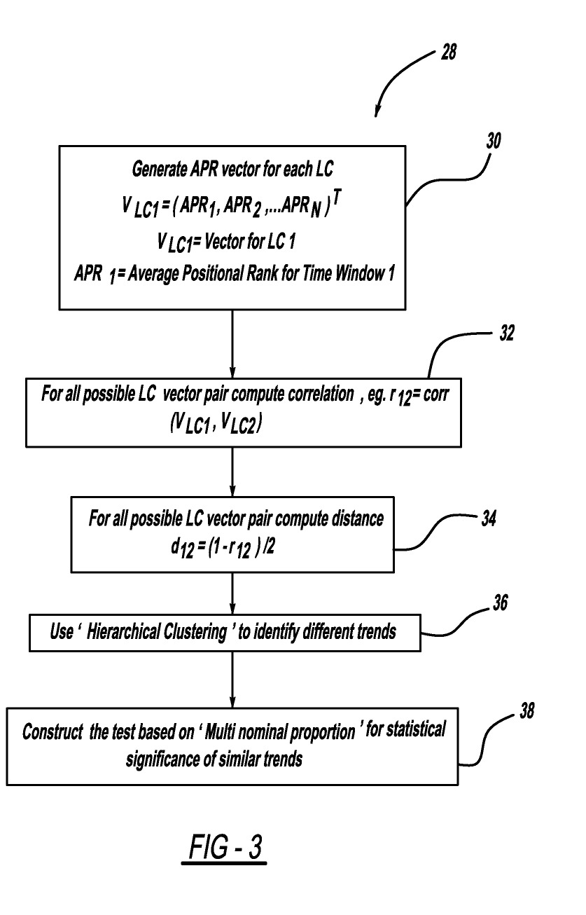

FIG. 3 is a flow diagram 28 of the process for clustering and change detection at the box 18, which essentially determines how many times the slope for a given APR has changed in the positive direction. First, an APR vector is generated for each labor code at box 30 using the equation:

V_{LC1}=(APR₁, APR_{2, . . . ,} APRₙ) (2)

Where AAR₁ is the average positional rank for time window 1.

After all of the labor code vectors are calculated at the box 30, all of the possible correlations for labor code vector pairs are calculated at box 32. An example calculation is given by equation:

r₁₂=corr(V_{LC1}, V_{LC2}) (3)

The distance for all possible labor code vector pairs is computed at box 34 using the equation:

$${d}_{12} = l - ( \frac{{r}_{12}}{2} ) \qquad ( 4 )$$

Next, the process uses ‘hierarchical clustering’ to identify different trends, and constructs a test based on a multi-nominal proportion for statistical significance of similar trends.

FIG. 4 is a graph with APR on the y-axis and time window increments on the x-axis showing how APR based trends change with different time windows. By carrying out some change point detection, such as multi-nominal hypothesis testing, one can capture these trends. To frame the multi-nominal hypothesis testing four steps are involved. A first step is to compute average growth rate (AGR) for each labor code using the equation:

$$A G {R}_{j , j + 1} = \frac{( A P {R}_{J + 1} - A P {R}_{J} )}{( j + 1 ) - j} \qquad ( 5 )$$

In a second step, the process counts the ‘sign’ {+ve, −ve, neutral} for each AGR. A third step evaluates the proportion of each of the categories {π₁, π₂, π₃}, and a fourth step frames the hypothesis testing for the trends utilizing the equations:

H₀: π₃>π₁, π₁>π₂

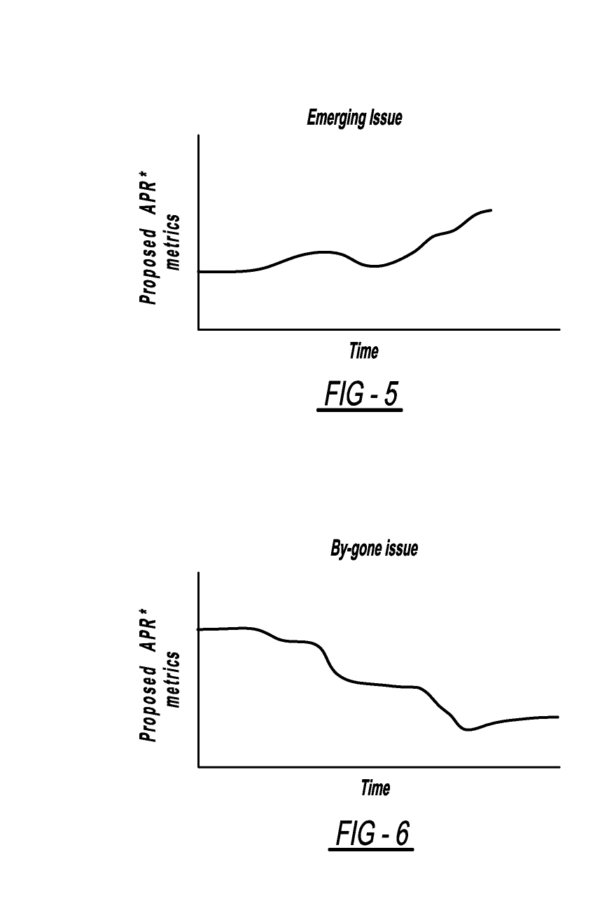

H₀: π₁>π₃, π₃>π₁ (6)

Where each of the respective developed H₀ is utilized to determine clusters, where cluster one relates to the first H₀ equation and indicates sudden emerging issues, as indicated by an increase in slope over time, as shown in FIG. 5, and the second H₀ equation relates to a second cluster and indicates by-gone issues, which is indicated by a decrease in slope over time, as shown in FIG. 6.

For emerging issues, illustrated in FIG. 5, the fusion of the sensitivity and the severity of the data allows the user to detect the emergence of issues more quickly and accurately. For by-gone issues, illustrated in FIG. 6, the fusion of the sensitivity and the severity of the data allows the user to determine when an issue is a by-gone issue more quickly and accurately. These benefits allow for enhanced management of issues and potentially reduced the costs associated therewith.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for temporal trend detection employing a non-parametric technique, said method comprising:
providing data;
assigning a rank to the data based on both sensitivity and severity of the data;
statistically ranking the ranked data by categorizing the data in bins defined by an average positional ranking that identifies the severity of the data for each sensitivity category provided by a bin;
clustering the statistically ranked data that has been categorized by average positional ranking so as to detect changes in the data; and
identifying trends in the data based on the detected changes.

2. The method according to claim 1 wherein assigning a rank to the data includes plotting the data as a histogram for a Kernel density estimation.

3. The method according to claim 2 wherein plotting the data includes using the equation:
$${\hat{f}}_{h} ( x ) = \frac{1}{Nh} {\sum }_{i = 1}^{N} K ( \frac{x - {x}_{i}}{h} )$$
where \hat{f}ₕ is a Kernel density approximation function, K is a Kernel function, x is an ID sample of a random sample variable, and h is bandwidth.

4. The method according to claim 1 wherein statistically ranking the ranked data includes categorizing the data based on occurrence and assigning a positional weight for each rank of data.

5. The method according to claim 4 wherein statistically ranking the data includes calculating the rank of the data and the positional weight of the data, calculating a probability of occurrence of an event based on the calculated rank of the data and the positional weight of the data, calculating an average positional rank of the data based on the probability of occurrence and calculating the average positional rank based on the probability of occurrence and the positional weight of the data.

6. The method according to claim 1 wherein detecting changes in the data includes generating an average positional rank vector from the data, calculating vector pairs from the data, calculating distances for all possible vector pairs in the data and using hierarchical clustering to identify different trends.

7. The method according to claim 1 wherein clustering the statistically ranked data includes employing a multi-nominal hypothesis testing procedure.

8. The method according to claim 7 wherein the multi-nominal hypothesis testing procedure computes an average growth rate for the data, counts the signs for each average growth rate, evaluates a proportion of each process count category and frames the hypothesis testing for a trend.

9. The method according to claim 1 wherein identifying trends in the data includes identifying emerging issues and by-gone issues.

10. The method according to claim 1 wherein the data is warranty data for a vehicle.

11. The method according to claim 10 wherein the data includes labor codes.

12. A method for temporal trend detection of vehicle warranty data including labor codes, said method comprising:
assigning a rank to the data based on both sensitivity and severity of the data including plotting the data as a histogram for a Kernel density estimation;
statistically ranking the ranked data by categorizing the data in bins defined by an average positional ranking that identifies the severity of the data for each sensitivity category provided by a bin, where statistically ranking the ranked data includes categorizing the data based on occurrence, assigning a positional weight for each rank of data, calculating the rank of the data and the positional weight of the data, calculating a probability of occurrence of an event based on the calculated rank of the data and the positional weight of the data, calculating an average positional rank of the data based on the probability of occurrence and calculating the average positional rank based on the probability of occurrence and positional weight of the data;
clustering the statistical ranked data that has been categorized by average positional ranking so as to detect changes in the data by employing a multi-nominal hypothesis testing procedure; and
identifying trends in the data based on the detected changes so as to identify emerging issues and by-gone issues.

13. The method according to claim 12 wherein plotting the data includes using the equation:
$${\hat{f}}_{h} ( x ) = \frac{1}{Nh} {\sum }_{i = 1}^{N} K ( \frac{x - {x}_{i}}{h} )$$
where \hat{f}ₕ is a Kernel density approximation function, K is a Kernel function, x is an ID sample of a random sample variable, and h is bandwidth.

14. The method according to claim 12 wherein detecting changes in the data includes generating an average positional rank vector from the data, calculating vector pairs from the data, calculating distances for all possible vector pairs in the data and using hierarchical clustering to identify different trends.

15. The method according to claim 12 wherein the multi-nominal hypothesis testing procedure computes an average growth rate for the data, counts the signs for each average growth rate, evaluates a proportion of each process count category and frames the hypothesis testing for a trend.

16. A system for temporal trend detection of data, said system comprising:
means for assigning a rank to the data based on both sensitivity and severity of the data including plotting the data as a histogram for a Kernel density estimation;
means for statistically ranking the ranked data by categorizing the data in bins defined by an average positional ranking that identifies the severity of the data for each sensitivity category provided by a bin, where the means for statistically ranking the ranked data categorizes the data based on occurrence, assigns a positional weight for each rank of data, calculates the rank of the data and the positional weight of the data, calculates a probability of occurrence of an event based on the calculated rank of the data and the positional weight of the data, calculates an average positional rank of the data based on the probability of occurrence and calculates the average positional rank based on the probability of occurrence and positional weight of the data;
means for clustering the statistical ranked data that has been categorized by average positional ranking so as to detect changes in the data by employing a multi-nominal hypothesis testing procedure; and
means for identifying trends in the data based on the detected changes so as to identify emerging issues and by-gone issues.

17. The system according to claim 16 wherein the means for assigning a rank plots the data using the equation:
$${\hat{f}}_{h} ( x ) = \frac{1}{Nh} {\sum }_{i = 1}^{N} K ( \frac{x - {x}_{i}}{h} )$$
where \hat{f}ₕ is a Kernel density approximation function, K is a Kernel function, x is an ID sample of a random sample variable, and h is bandwidth.

18. The system according to claim 16 wherein means for clustering the statistical ranked data detects changes in the data by generating an average positional rank vector from the data, calculating vector pairs from the data, calculating distances for all possible vector pairs in the data and using hierarchical clustering to identify different trends.

19. The system according to claim 16 wherein the multi-nominal hypothesis testing procedure computes an average growth rate for the data, counts the signs for each average growth rate, evaluates a proportion of each process count category and frames the hypothesis testing for a trend.

20. The system according to claim 16 wherein the data is vehicle warranty data including labor codes.
